(19) United States
(12) Patent Application Publication
(10) Pub. No.: US 2013/0260236 A1
(43) Pub. Date: Oct. 3, 2013

(54) NEGATIVE-ELECTRODE MATERIAL FOR ELECTRICITY STORAGE DEVICE, AND NEGATIVE ELECTRODE FOR ELECTRICITY STORAGE DEVICE USING SAME

(71) Applicants: Gumjae Park, Osaka (JP); Tetsuo Sakai, Osaka (JP); Hideo Yamauchi, Shiga (JP); Tomohiro Nagakane, Shiga (JP); Akihiko Sakamoto, Shiga (JP)

(72) Inventors: Gumjae Park, Osaka (JP); Tetsuo Sakai, Osaka (JP); Hideo Yamauchi, Shiga (JP); Tomohiro Nagakane, Shiga (JP); Akihiko Sakamoto, Shiga (JP)

(21) Appl. No.: 13/881,200

(22) PCT Filed: Nov. 4, 2011
(86) PCT No.: PCT/JP2011/075498

§ 371 Date: May 30, 2013

(30) Foreign Application Priority Data
Nov. 8, 2010 (JP) 2010-249752

(51) Int. Cl. H01M 4/62; H01G 11/46; H01G 11/06

(52) U.S. Cl. CPC H01M 4/622; H01G 11/06; H01G 11/46
USPC 429/211; 361/502; 429/217

(57) ABSTRACT

The negative electrode material for an electricity storage device comprising a negative electrode active material containing an oxide material, and a binder made of a water-soluble polymer. As the water-soluble polymer, a cellulose derivative or polyvinyl alcohol can be used.

### TECHNICAL FIELD

The present invention relates to a negative electrode material for an electricity storage device (hereinafter, also simply referred to as “negative electrode material”), such as a non-aqueous lithium ion secondary battery, which is used in a portable electronic appliance or an electric vehicle, and to a negative electrode for an electricity storage device using the negative electrode material.

### BACKGROUND ART

In recent years, in association with widespread use of an electricity storage device in on-vehicle applications and the like as well as in portable personal computers and portable phones, it has been highly demanded to develop an electricity storage device such as a lithium ion secondary battery having a higher capacity and a reduced size. When an electricity storage device has a higher capacity, reduction in size of a battery material can be facilitated, and hence the development of an electrode material for an electricity storage device is urgently needed in order to accomplish the higher capacity. Further, the electricity storage device is also desired to have a high-speed discharge (high-rate) performance, because the electricity storage device is anticipated to be used at about 3 C rate discharge when used as an electric source of a portable electronic device such as a digital camera and to be used at about 10 C. or more rate discharge when equipped in a vehicle such as a hybrid electric vehicle.

For example, high potential type materials such as LiCoO₂, LiCo₁₋ₓNiₓO₂, LiNiO₂, and LiMn₂O₄ are each widely used for a positive electrode material for a lithium ion secondary battery, and on the other hand, a carbonaceous material is generally used for a negative electrode material. These materials function as electrode active materials that reversibly store and release lithium ions through charge and discharge, and constitute a so-called rocking chair type secondary battery in which both electrodes are electrochemically connected through a non-aqueous electrolytic solution or a solid electrolyte.

Examples of the carbonaceous material used as a negative electrode material include a graphite carbon material, pitch coke, fibrous carbon, and high-capacity type soft carbon prepared by low-temperature firing. However, the carbonaceous material has a relatively small lithium insertion capacity, and hence involves a problem in that the carbonaceous material has a low capacity. Specifically, even if a lithium insertion capacity in a stoichiometric amount is attained, the capacity of the carbon material is limited up to about 372 mAh/g.

In view of the foregoing, there is proposed a negative electrode active material comprising a metal such as Si or Sn, or SnO, as a negative electrode active material that is capable of storing and releasing lithium ions and has a higher capacity density than that of the carbonaceous material (see, for example, Patent Literature 1 and Non Patent Literature 1).

### CITATION LIST

Patent Literature 1: JP 2887632 B
Non Patent Literature 1: M. Winter, J. O. Besenhard, Electrochimica Acta, 45 (1999), p. 31

### SUMMARY OF INVENTION

### Technical Problem

A negative electrode active material comprising a metal such as Si or Sn, or SnO is excellent in initial charge-discharge efficiency (ratio of an initial discharge capacity to an initial charge capacity), but has a remarkably large volume change due to the storage and release reactions of lithium ions during charge and discharge. As a result, repeated charge and discharge causes degradation of the structure of the negative electrode material, and hence a crack is liable to occur. If the crack develops, a void is formed in the negative electrode material in some cases, and the negative electrode material may become finely-divided. When a crack occurs in the negative electrode material, an electron-conducting network is divided, which results in a problem of a reduction in discharge capacity after repeated charge and discharge (cycle performance).

Further, in each of the negative electrode materials disclosed in the above literatures, in order to bind particles of the negative electrode active material to each other, a thermoplastic straight-chain polymer such as polyvinylidene fluoride (PVDF) or polytetrafluoroethylene (PTFE) or a polymer such as styrene-butadiene rubber (SBR) is used as a binder. Any of these polymers is usually used in water dispersion, but is insoluble in water, and hence, when an electrode paste is prepared by using any of these polymers, an electrode material is liable to separate and deposit in water, so that it has been difficult to disperse the electrode material uniformly in the electrode paste.

Further, polymers such as PVDF, PTFE, and SBR are non-polar materials, and hence involve a problem in that hydrophobic groups thereof interact with each other in water, and as time passes, the aggregation thereof occurs. As a result, the polymer cannot sufficiently include negative electrode active material to cause reduction in binding force, and hence the capacity remarkably reduces when charge and discharge is repeated. In addition, when a binder aggregates in an electrode, the aggregated part becomes an electrically insulated part in the electrode. When an electricity storage device using such the electrode is charged and discharged, an irregular flow of electricity occurs in the electrode, with the result that not only deterioration in the high-rate performance but also abnormal heat generation occur in apart of electric charge concentration.

By the above-mentioned reasons, any of the above polymers may be used in dissolution in a non-polar organic solvent such as N-methylpyrrolidinone, but the use of organic solvents leads to a heavy load on the environment. Further, these thermoplastic polymers and organic solvents are expensive, thus also having caused a problem in that the resultant electricity storage device has high cost.

Thus, the present invention has been made in view of the situations described above, and intends to provide a negative electrode material for an electricity storage device, which has a high capacity and an excellent initial charge-discharge performance, being excellent in cycle performance and high-rate performance, being excellent in safety, having a low load on the environment, and being low in cost, and also to provide a negative electrode for an electricity storage device formed by using such the negative electrode material.

### Solution to Problem

The inventors of the present invention have made various studies and have consequently found that the above-mentioned problems can be solved by a negative electrode material which comprises a negative electrode active material containing a particular oxide material and a binder made of a particular material. Thus, the inventors have proposed the finding as the present invention.

That is, the present invention presents a negative electrode material for an electricity storage device comprising, a negative electrode active material containing an oxide material, and a binder made of a water-soluble polymer.

The present invention is characterized in that a water-soluble polymer is used as a binder. Thereby, it is possible to prevent the negative electrode active material frombeing detached from the negative electrode material due to volume change of the of the negative electrode active material during charge and discharge. That is, the negative electrode active material containing an oxide material has hydroxyl groups (—OH) in an outermost surface thereof and the water-soluble polymer also has hydroxyl groups. Thus, the hydroxyl groups in the outermost surface of the negative electrode active material undergo dehydration condensation with any of the hydroxyl groups in the water-soluble polymer, particles of the negative electrode active material can be firmly bound to each other in the negative electrode material, and hence the negative electrode active material can be prevented from being detached from the negative electrode material. Further, the use of a water-soluble polymer as a binder contributes to achieving low resistance of the resultant negative electrode, thereby being able to improve the high-rate performance thereof, though the details of the mechanism of such the above phenomenon are not figured out.

Note that a water-soluble polymer is highly soluble in water, and hence it is possible to disperse the water-soluble polymer uniformly in a solvent without using a non-polar organic solvent, unlike the previously described thermoplastic straight-chain polymers and polymers such as SBR. It is therefore possible to manufacture a negative electrode material which has a low load on the environment, is low in cost, and is excellent in safety.

In the negative electrode material for an electricity storage device of the present invention, the water-soluble polymer is preferably a cellulose derivative or polyvinyl alcohol.

Among water-soluble polymers, cellulose derivatives (cellulose esters, cellulose ethers, and the like) each have a strong network formed of glucose units, and each have hydroxyl groups or carboxyl groups (—COOH) on parts of side chains thereof. Further, polyvinyl alcohol has many hydroxyl groups on side chains thereof. Thus, these water-soluble polymers are excellent in affinity to the surfaces of a negative electrode active material and easily form firm binding to the surfaces. Thus, particles of the negative electrode active material are firmly bound to each other, and hence the negative electrode active material can be prevented from being detached from the negative electrode material even when the volume change of the negative electrode active material occurs during charge and discharge. Further, the use of a cellulose derivative or polyvinyl alcohol as a binder contributes to achieving low resistance of the resultant negative electrode, thus particularly easily providing the effect of improving the high-rate performance thereof. In addition, each of cellulose derivatives or polyvinyl alcohol has a particularly small load on the environment and is low in cost because they are mass-produced.

The negative electrode material for an electricity storage device of the present invention preferably comprises the binder at 2 to 30 mass %.

In the negative electrode material for an electricity storage device of the present invention, the oxide material preferably comprises P₂O₅ and/or B₂O₃.

The negative electrode active material comprising the oxide material containing P₂O₅ and/or B₂O₃ has many hydroxyl groups in an outermost surface thereof, thus having many binding sites to a water-soluble polymer, and hence particles of the negative electrode active material can be bound very firmly to each other in the negative electrode material. Further, as described below, the negative electrode active material comprising the oxide material containing P₂O₅ and/or B₂O₃ exhibits a small volume change during a charge and discharge reaction, and hence it is possible to prevent the negative electrode active material from being detached from a negative electrode current collector.

In the negative electrode material for an electricity storage device of the present invention, the oxide material is preferably made of a compound comprising P₂O₅ and/or B₂O₃ and SnO.

It is known that, in a lithium ion secondary battery, which is one example of a non-aqueous secondary battery as an electricity storage device, the following reactions take place in its negative electrode during charge and discharge.

Sn^{x+}+xe⁻→Sn (1)

Sn+yLi⁺+ye⁻ [symbol] Li_{y}Sn (2)

First, during the initial charge, an irreversible reaction in which Sn^{x+} ion receives an electron, generating metal Sn, takes place (formula (1)). Subsequently, there occurs a reaction in which the generated metal Sn is bound to lithium ion that has transferred from the positive electrode through an electrolytic solution or a solid electrolyte and electron supplied from a circuit, forming Sn—Li alloy. The reaction occurs as a reversible reaction that proceeds in the right direction during charge and proceeds in the left direction during discharge (formula (2)).

Here, attention is paid to the reaction of the formula (1), which takes place during the initial charge. As the energy which is necessary for causing the reaction is smaller, an initial charge capacity becomes smaller, resulting in excellent initial charge-discharge efficiency. Thus, as the valence of Sn^{x+} ion is smaller, the number of electrons necessary for reduction becomes smaller, and hence the smaller valence is advantageous for improving the initial charge-discharge efficiency of the secondary battery.

By the way, when Sn^{x+} ion is formed into Li_{y}Sn alloy during the initial charge, the negative electrode material stores y pieces of lithium ions released from the positive electrode material, causing a volume expansion thereof. This volume change can be calculated from the standpoint of crystallography. For example, SnO crystal has a tetragonal system whose crystal unit cell has lengths of 3.802 Å by 3.802 Å by 4.836 Å, and hence its crystal unit volume comes to 69.9 Å³. The crystal unit cell comprises two Sn atoms, and hence the occupied volume of one Sn atom comes to 34.95 Å³. On the other hand, alloys of Li_{2.6}Sn, Li_{3.5}Sn, Li_{4.4}Sn, and the like are known as Li_{y}Sn alloys formed during charge. For example, considering a case where Li_{4.4}Sn alloy is formed during charge, the unit cell of Li_{4.4}Sn (cubic system, space group F23) has lengths of 19.78 Å by 19.78 Å by 19.78 Å, and hence its cell unit volume comes to 7,739 Å³. The unit cell comprises 80 Sn atoms, and hence the occupied volume of one Sn atom comes to 96.7 Å³. Thus, when SnO crystal is used for the negative electrode material, the occupied volume of Sn atom expands 2.77-fold (96.7 Å³/34.95 Å³) during the initial charge.

Next, during discharge, the reaction in the formula (2) proceeds in the left direction and y pieces of lithium ions and y pieces of electrons are released from the Li_{y}Sn alloy, forming metal Sn, and hence the volume of the negative electrode material contracts. In this case, the contraction rate of the volume is calculated from the standpoint of crystallography as described previously. Metal Sn has a tetragonal system whose unit cell has lengths of 5.831 Å by 5.831 Å by 3.182 Å, and hence its unit cell volume comes to 108.2 Å³. The unit cell comprises four Sn atoms, and hence the occupied volume of one Sn atom comes to 27.05 Å³. Thus, in a case where Li_{y}Sn alloy is Li_{4.4}Sn alloy, when a discharge reaction proceeds in the negative electrode material, generating metal Sn, and consequently, the occupied volume of Sn atom contracts 0.28-fold (27.5 Å³/96.7 Å³).

Further, during the second charge onward, the reaction in the formula (2) proceeds in the right direction and metal Sn stores y pieces of lithium ions and y pieces of electrons, producing an Li_{y}Sn alloy, and hence the volume of the negative electrode material expands. In this case, when the metal Sn is formed into Li_{4.4}Sn, the occupied volume of the Sn atom expands 3.52-fold (96.7 Å³/27.5 Å³).

As described above, the negative electrode material containing SnO undergoes a remarkable volume change during charge and discharge, and hence repeated charge and discharge is liable to generate a crack in the negative electrode material. If the crack develops, a void is formed in the negative electrode material in some cases, and the negative electrode material may become finely-divided. Also, when a crack occurs in the negative electrode material, an electron-conducting network is divided. As a result, the charge-discharge capacity of the negative electrode material is liable to lower, causing the reduction of cycle performance thereof.

In the present invention, Sn^{x+} ions in the negative electrode material are present in the state of being covered by a phosphate network and/or a borate network, and hence the phosphate network and/or the borate network can contribute to abating the volume change of Sn atom due to charge and discharge. As a result, it is possible to obtain an electricity storage device which is excellent in cycle performance during repeated charge and discharge.

In the negative electrode material for an electricity storage device of the present invention, the oxide material preferably comprises, as a composition in terms of mol %, 45 to 95% of SnO and 5 to 55% of P₂O₅.

In the negative electrode material for an electricity storage device of the present invention, the oxide material preferably comprises, as a composition in terms of mol %, 10 to 85% of SnO, 3 to 90% of B₂O₃, and 0 to 55% of P₂O₅ (provided that B₂O₃+P₂O₅ is 15% or more).

In the negative electrode material for an electricity storage device of the present invention, the negative electrode active material preferably further comprises at least one kind of metal material selected from Si, Sn, Al, and an alloy containing any one of Si, An, and Al.

At least one kind of metal material selected from Si, Sn, Al, and an alloy containing any one of them, which can store and release lithium ions and electrons, functions as a negative electrode active material, and hence it is possible to further improve the initial charge-discharge efficiency. It is known that the following reaction takes place in each of these metal materials during charge and discharge.

M+zLi⁺+ze⁻ [symbol] Li_{z}M (2′)

(M represents at least one kind selected from Si, Sn, Al, and an alloy containing any one of them.)

Here, the at least one kind of metal material selected from Si, Sn, Al, and an alloy containing any one of them has a large storing amount of lithium ions, and hence involves remarkable volume expansion when Li_{z}M alloy is formed during charge. In a case where metal Sn, for example, is used as a negative electrode active material, metal Sn stores 4.4 lithium ions and electrons from the positive electrode during charge, and the volume expands by about 3.52 times. Thus, if such the negative electrode active material is used alone to prepare the negative electrode material, a crack is liable to occur in the negative electrode material during repeated charge and discharge, causing the deterioration of the cycle performance thereof.

When the metal material is made complex with the oxide material comprising P₂O₅ and/or B₂O₃, the metal material is present in the state of being covered by the oxide material structured with a phosphate network and/or a borate network, and hence the oxide material formed of the phosphate network and/or the borate network can contribute to abating the volume change of the metal material due to charge and discharge. Further, lithium ions each having a small ion radius and having a positive electric field are stored in the phosphate network and/or the borate network, and then the shrinkage of each network occurs, resulting in the reduction of the molar volume thereof. That is, the phosphate network and/or the borate network not only have the function of abating the increase of the volume of the metal material due to charge, but also have the function of suppressing the increase. Thus, even when charge and discharge is repeated, a crack in the negative electrode material due to the volume change can be suppressed, and hence the cycle performance thereof can be prevented from deteriorating.

The negative electrode material for an electricity storage device of the present invention preferably further comprises a conductive aid.

The conductive aid forms an electron-conducting network in the negative electrode material, enabling the negative electrode material to have a higher capacity and a higher rate.

The present invention also provides a negative electrode for an electricity storage device which comprises a current collector having a surface coated with any one of the above-mentioned negative electrode materials for an electricity storage device.

### BRIEF DESCRIPTION OF DRAWING

FIG. 1 is a graph illustrating the discharge capacities of each negative electrode active material, the discharge capacities being measured when an electric current was changed from 0.2 C to 20 C rate during discharge in Example 8 and Comparative Example 1.

### DESCRIPTION OF EMBODIMENTS

The negative electrode material for an electricity storage device of the present invention comprises a negative electrode active material containing an oxide material, and a binder made of a water-soluble polymer.

A water-soluble polymer is used as the binder. Examples of the water-soluble polymer include: cellulose derivatives such as carboxymethyl cellulose, hydroxypropylmethyl cellulose, hydroxypropyl cellulose, hydroxyethyl cellulose, ethyl cellulose, and hydroxymethyl cellulose; starch and starch derivatives such as carboxymethyl starch, starch phosphate, and cationic starch; natural plant polymers such as xanthan gum, guar gum, alginic acid, gum arabic, carrageenan, sodium chondroitin sulfate, sodium hyaluronate, chitosan, and gelatin; nonionic synthetic polymers such as polyvinyl alcohol, polyacrylamide, polyvinylpyrrolidone and a copolymer thereof, polyethylene glycol, polymethyl vinyl ether, and polyisopropyl acrylamide; anionic synthetic polymers such as sodium polyacrylate and a copolymer thereof, sodium polystyrene sulfonate, a copolymer of sodium polyisoprene sulfonate, a naphthalenesulfonic acid condensate salt, and a xanthate salt of polyethyleneimine; cationic synthetic polymers such as a homopolymer of dimethyldiallylammonium chloride and a copolymer thereof, polyamide and a copolymer thereof, polyvinyl imidazoline, and polyethyleneimine; and amphiphatic synthetic polymers such as a dimethylaminoethyl(meth)acrylate quaternary salt-acrylic acid copolymer and a Hofmann degradation product of polyacrylamide.

Of those, cellulose derivatives such as carboxymethyl cellulose, hydroxypropylmethyl cellulose, hydroxypropyl cellulose, hydroxyethyl cellulose, ethyl cellulose, and hydroxymethyl cellulose, and polyvinyl alcohol are preferred, and carboxymethyl cellulose and polyvinyl alcohol are most preferred, which are widely used in the field of industry and low cost.

Note that, the term “carboxymethyl cellulose” as used herein intends to encompass a carboxymethyl cellulose salt such as sodium carboxymethyl cellulose.

Each of those binders may be used alone, or two or more kinds thereof may be used as a mixture.

The content of the binder in the negative electrode material is preferably 2 to 30 mass % or 3 to 28 mass %, particularly preferably 4 to 25 mass %. When the content of the binder is less than 2 mass %, the property of binding the negative electrode active material and the conductive aid is poorly exhibited, and hence the negative electrode active material is liable to be detached from the negative electrode material due to the volume change of the volume of the negative electrode active material during repeated charge and discharge, and consequently, the cycle performance tends to deteriorate. On the other hand, when the content of the binder is more than 30 mass %, the amount of the binder interposing between particles of the negative electrode active material (or the conductive aid) in the negative electrode material increases, and hence the electron-conducting network is divided, with the result that a higher capacity cannot be achieved and the high-rate performance tends to deteriorate remarkably.

For example, the material comprising P₂O₅ and/or B₂O₃ may be used as the oxide material contained in the negative electrode active material, and in particular, the compound comprising P₂o₅ and/or B₂O₃ and SnO may be used. Specific examples of the oxide material include a material comprising, as a composition in terms of mol %, 45 to 95% of SnO and 5 to 55% of P₂O₅ (composition A), and a material comprising, as a composition in terms of mol %, 10 to 85% of SnO, 3 to 90% of B₂O₃, and 0 to 55% of P₂O₅ (provided that B₂O₃+P₂O₅ is 15% or more) (composition B). The reasons why each composition is defined as described above are described below.

(Composition A)

SnO is an active material component serving as a site for storing and releasing lithium ions. The content of SnO is preferably 45 to 95%, 50 to 90%, 55 to 87%, 60 to 85%, or 68 to 83%, particularly preferably 71 to 82%. When the content of SnO is less than 45%, charge-discharge capacity per unit mass of the oxide material becomes smaller, with the result that the charge-discharge capacity of the negative electrode active material also becomes smaller. On the other hand, when the content of SnO is more than 95%, the amount of amorphous components in the negative electrode active material becomes smaller, it is thus difficult to abate the volume change due to the storage and release of lithium ions during charge and discharge, and consequently, a rapid reduction in discharge capacity may occur. Note that the content of the SnO component in the present invention refers to a total content additionally including the contents of tin oxide components (such as SnO₂) other than SnO, provided that the contents of such the tin oxide components are calculated in terms of SnO.

P₂O₅ is a network-forming oxide, covers a site of SnO for storing and releasing lithium ions, and functions as a solid electrolyte in which lithium ions are movable. The content of P₂O₅ is preferably 5 to 55%, 10 to 50%, 13 to 45%, 15 to 40%, or 17 to 32%, particularly preferably 18 to 29%. When the content of P₂O₅ is less than 5%, it is difficult to abate the volume change of SnO due to the storage and release of lithium ions during charge and discharge, resulting in structural degradation, and hence the discharge capacity is liable to lower during repeated charge and discharge. On the other hand, when the content of P₂O₅ is more than 55%, the water resistance is liable to deteriorate. Further, in a case where an aqueous electrode paste is prepared by using the negative electrode material, different kinds of crystals (such as SnHPO₄) which do not contribute to a charge and discharge reaction are formed in a large amount, and hence the capacity is liable to lower during repeated charge and discharge. Further, a stable crystal (such as SnP₂O₇) is liable to be formed together with Sn atom, and there is brought about such a state that the influence of coordination bonds of lone pairs of electrons owned by each oxygen atom in chain P₂O₅ on Sn atom is stronger. As a result, many electrons are necessary for reducing Sn ions in the formula (1), and hence the initial charge-discharge efficiency tends to lower.

Various components can be further added to the oxide material in addition to the above-mentioned components. For example, CuO, ZnO, B₂O₃, MgO, CaO, Al₂O₃, SiO₂, and R₂O (R represents Li, Na, K, or Cs) may be contained at a total content of preferably 0 to 20% or 0 to 10%, particularly preferably 0.1 to 7%. When the total content of these components is more than 20%, the resultant negative electrode material is liable to have a disordered structure, resulting in an amorphous material, but its phosphate network is liable to be divided. As a result, the volume change of the negative electrode active material due to charge and discharge cannot be abated, possibly resulting in the deterioration of the cycle performance.

Note that SnO/P₂O₅ (molar ratio) is preferably 0.8 to 19 or 1 to 18, particularly preferably 1.2 to 17. When the SnO/P₂O₅ is less than 0.8, Sn atom in SnO is liable to be influenced by the coordination of P₂O₅. As a result, the initial charge-discharge efficiency tends to lower. On the other hand, when the SnO/P₂O₅ is more than 19, the discharge capacity is liable to lower during repeated charge and discharge. This is probably because the number of P₂O₅ molecules coordinating to SnO decreases in the oxide, P₂O₅ cannot sufficiently cover SnO, and consequently, it is difficult to abate the volume change of SnO due to the storage and release of lithium ions, causing structural degradation.

(Composition B)

SnO is an active material component serving as a site for storing and releasing lithium ions. The content of SnO is preferably 10 to 85%, 30 to 83%, or 40 to 80%, particularly preferably 50 to 75%. When the content of SnO is less than 10%, the charge-discharge capacity per unit mass of the oxide material becomes smaller. As a result, the charge-discharge capacity of the resulting negative electrode active material also becomes smaller. On the other hand, when the content of SnO is more than 85%, the amount of amorphous components in the negative electrode active material becomes smaller, and hence it is difficult to abate the volume change due to the storage and release of lithium ions during charge and discharge. Consequently, the discharge capacity may rapidly lower.

B₂O₃ is a network-forming oxide, covers a site of SnO for storing and releasing lithium ions, abates the volume change due to the storage and release of lithium ions during charge and discharge, and functions to maintain the structure of the oxide material. The content of B₂O₃ is preferably 3 to 90%, 5 to 70%, or 7 to 60%, particularly preferably 9 to 55%. When the content of B₂O₃ is less than 3%, it is difficult to abate the volume change of SnO due to the storage and release of lithium ions during charge and discharge, resulting in structural degradation, and hence the discharge capacity is liable to lower during repeated charge and discharge. On the other hand, when the content of B₂O₃ is more than 90%, there is brought about such a state that the influence of coordination bonds of lone pairs of electrons owned by each oxygen atom existing in a borate network on Sn atom is stronger. As a result, many electrons are necessary for reducing Sn ions during the initial charge, and hence the initial charge-discharge efficiency tends to lower. Further, the content of SnO becomes relatively smaller, the charge-discharge capacity per unit mass of the oxide material becomes smaller, and consequently, the charge-discharge capacity of the resulting negative electrode active material tends to become smaller as well.

P₂O₅ is a network-forming oxide, and forms a complex network by being intertwined with a borate network in a three-dimensional manner, thereby being able to cover a site of SnO for storing and releasing lithium ions, abating the volume change due to the storage and release of lithium ions during charge and discharge, and functioning to maintain the structure of the oxide material. The content of P₂O₅ is preferably 0 to 55% or 5 to 50%, particularly preferably 10 to 45%. When the content of P₂O₅ is more than 55%, the water resistance is liable to deteriorate. Further, in a case where an aqueous electrode paste is prepared by using the negative electrode material, different kinds of crystals (such as SnHPO₄) which do not contribute to a charge and discharge reaction are formed in a large amount, and hence the capacity is liable to lower during repeated charge and discharge. Further, there is brought about such a state that the influence of coordination bonds of lone pairs of electrons owned by each oxygen atom existing in a phosphate network and a borate network on Sn atom is stronger. As a result, many electrons are necessary for reducing Sn ions during the initial charge, and hence the initial charge-discharge efficiency tends to lower. Further, the content of SnO becomes relatively smaller, the charge-discharge capacity per unit mass of the oxide material becomes smaller, and consequently, the charge-discharge capacity of the resulting negative electrode active material tends to become smaller as well.

Note that the total content of B₂O₃ and P₂O₅ is preferably 15% or more or 20% or more, particularly preferably 30% or more. When the total content of B₂O₃ and P₂O₅ is less than 15%, it is difficult to abate the volume change of SnO due to the storage and release of lithium ions during charge and discharge, resulting in structural degradation, and hence the discharge capacity is liable to lower during repeated charge and discharge.

Besides, various components can be added to the oxide material in addition to the above-mentioned components in order to facilitate vitrification. For example, CuO, ZnO, MgO, CaO, Al₂O₃, SiO₂, and R₂O (R represents Li, Na, K, or Cs) can be contained at a total content of preferably 0 to 20% or 0 to 10%, particularly preferably 0.1 to 7%. When the total content of these components is more than 20%, the resultant negative electrode material is liable to have a disordered structure, resulting in an amorphous material, but a phosphate network or a borate network is liable to be divided. As a result, the volume change of the negative electrode active material due to charge and discharge cannot be abated, possibly resulting in the deterioration of the cycle performance.

The oxide material has a crystallinity of preferably 95% or less, 80% or less, 70% or less, or 50% or less, particularly preferably 40% or less, and is most preferably substantially amorphous. In the oxide material containing SnO at a high ratio, as the crystallinity thereof is smaller (as the ratio of amorphous phase is larger), the volume change during repeated charge and discharge can be more abated, which is advantageous from the viewpoint of suppressing a lowering of the discharge capacity.

The crystallinity is determined by performing peak separation to each crystalline diffraction line and an amorphous halo in a diffraction line profile ranging from 10 to 60° in terms of the 2θ value obtained by powder X-ray diffraction measurement using CuKα-rays. Specifically, when an integral intensity obtained by performing the peak separation of a broad diffraction line (amorphous halo) in the range of 10 to 45° from a total scattering curve obtained by performing background subtraction from the diffraction line profile is defined as Ia, and the total sum of integral intensities obtained by performing the peak separation of each crystalline diffraction line detected in the range of 10 to 60° from the total scattering curve is defined as Ic, the crystallinity Xc can be calculated on the basis of the following equation.

Xc=[Ic/(Ic+Ia)]×100(%)

Note that the phrase “to be substantially amorphous” means that the crystallinity is substantially 0% (Specifically, the crystallinity is 0.1% or less.), and also refers to the condition in which no crystalline diffraction line is detected in powder X-ray diffraction measurement using CuKα-rays.

After charging and discharging an electricity storage device using the negative electrode active material of the present invention, the oxide material may comprise a phase formed of a complex oxide of a metal and an oxide, or an alloy phase of a metal and another metal.

In a case where the oxide material in the negative electrode active material is in a powder form, the oxide material has preferably an average particle diameter of 0.1 to 10 μm and a maximum particle diameter of 75 μm or less, an average particle diameter of 0.3 to 9 μm and a maximum particle diameter of 65 μm or less, or an average particle diameter of 0.5 to 8 μm and a maximum particle diameter of 55 μm or less, particularly preferably an average particle diameter of 1 to 5 μm and a maximum particle diameter of 45 μm or less. When the oxide material in the negative electrode active material has an average particle diameter of more than 10 pm or a maximum particle diameter of more than 75 μm, the resultant negative electrode material is liable to be detached from a current collector because it cannot be abated the volume change of the negative electrode active material due to the storage and release of lithium ions during charge and discharge. As a result, the capacity tends to be remarkably lowered when conducting repeated charge and discharge. Further, in a case where the oxide material is made complex with the metal material described below, it is difficult to cover uniformly each space between particles of the metal material with the oxide material, and the resultant negative electrode material is liable to be detached from a current collector, because it cannot be abated the volume change of the metal material due to the storage and release of lithium ions during charge and discharge. As a result, the capacity tends to be remarkably lowered when conducting repeated charge and discharge. On the other hand, when the average particle diameter of the powder is less than 0.1 μm, the powder is poorly dispersed when formed into a paste, and hence it tends to be difficult to prepare a homogeneous electrode.

Herein, the average particle diameter and the maximum particle diameter denote D50 (50 percent volume cumulative diameter) and D100 (100 percent volume cumulative diameter), respectively, in the median diameter of primary particles, and refer to values obtained by measurement with a laser diffraction particle size analyzer (SALD-2000 series manufactured by SHIMADZU CORPORATION).

Further, the specific surface area of the oxide material in a powder form measured by a BET method is preferably 0.1 to 20 m²/g or 0.15 to 15 m²/g, particularly preferably 0.2 to 10 m²/g. When the oxide material has a specific surface area of less than 0.1 m²/g, the storage and release of lithium ions cannot be performed rapidly, and charge and discharge times tend to be longer. On the other hand, when the oxide material has a specific surface area of more than 20 m²/g, when a paste for forming an electrode, which comprises a binder and water, is prepared, the powder is poorly dispersed so that the addition amounts of the binder and water need to be increased, or the paste has poor coatability, with the result that it tends to be difficult to form a homogeneous electrode.

Further, the tap density of the oxide material in a powder form is preferably 0.5 to 2.5 g/cm³, particularly preferably 1 to 2 g/cm³. When the oxide material has a tap density of less than 0.5 g/cm³, the filling amount per electrode unit volume of the negative electrode material is small, electrode density is thus poor, and hence it becomes difficult to attain a high capacity. On the other hand, when the oxide material has a tap density of more than 2.5 g/cm³, the filling state of the negative electrode material is too high for an electrolytic solution to penetrate easily, and consequently, a sufficient capacity may not be provided.

Note that the tap density herein refers to a value obtained by measurement under the conditions of a tapping stroke of 18 mm, a number of taps of 180, and a tapping rate of 1 tap/second.

In order to produce powder having predetermined sizes, a general grinding mill or classifier is used. There is used, for example, a mortar, a ball mill, an oscillating ball mill, a satellite ball mill, a planetary ball mill, a jet mill, a sieve, a centrifuge, or an air classifier.

The oxide material can be produced by, for example, melting raw material powders under heating, thereby causing vitrification thereof. Herein, raw material powders comprising Sn is particularly preferably melted in a reducing atmosphere or an inert atmosphere.

In the oxide material comprising Sn, the oxidation state of Sn atom is liable to change depending on melting conditions, and hence, when melting is carried out in an air atmosphere, undesirable SnO₂ crystal, SnP₂O₇ crystal, and the like are liable to be formed in the surface of a glass melt or in the glass melt. As a result, the initial charge-discharge efficiency and cycle performance of the resultant negative electrode material may deteriorate. Thus, when melting is carried out in a reducing atmosphere or an inert atmosphere, the increase of the valence of Sn ion in the oxide material can be suppressed, the formation of undesirable crystals can be suppressed, and consequently, an electricity storage device excellent in the initial charge-discharge efficiency and cycle performance can be provided.

In order to carry out melting in a reducing atmosphere, it is preferred to supply a reducing gas into a melting tank. It is preferred to use, as the reducing gas, a mixed gas comprising, in terms of vol %, 90 to 99.5% of N₂ and 0.5 to 10% of H₂, and it is particularly preferred to use a mixed gas comprising 92 to 99% of N₂ and 1 to 8% of H₂.

When melting is carried out in an inert atmosphere, it is preferred to supply an inert gas into a melting tank. It is preferred to use, as the inert gas, any of nitrogen, argon, and helium.

The reducing gas or the inert gas may be supplied into the upper atmosphere of molten glass in a melting tank, or may be directly supplied into molten glass from a bubbling nozzle. Both methods may be carried out at the same time.

Further, in the method of producing the oxide material described above, when a complex oxide is used as the starting raw material powder, it is easier to produce a negative electrode active material which is low in devitrified substance and is excellent in homogeneity. To use the negative electrode active material comprising such the oxide material facilitates the provision of an electricity storage device having a stable discharge capacity. Examples of such the complex oxide include stannous pyrophosphate (Sn₂P₂O₇).

Further, the raw material powder preferably comprises metal powder or carbon powder. Thus, the state of Sn atoms in the resultant oxide material can be shifted to a reduced state. As a result, the valence of Sn in the oxide material becomes smaller, and it is possible to improve the initial charge-discharge efficiency of an electricity storage device.

It is preferred to use, as the metal powder, powder of any one of Sn, Al, Si, and Ti. It is particularly preferred to use powder of any one of Sn, Al, and Si.

The content of the metal powder is, in terms of mol % on the oxide basis in the oxide material, preferably 0 to 20%, particularly preferably 0.1 to 10%. When the content of the metal powder is more than 20%, excess metal may deposit as a mass thereof from the oxide material, or SnO in the oxide material may be reduced, thus depositing as Sn particles in the state of agglomerate.

Note that the carbon powder is added into the raw material powder at preferably 0 to 20 mass %, particularly preferably 0.05 to 10 mass %.

The negative electrode active material may further comprise, in addition to the oxide material, at least one kind of metal material selected from Si, Sn, and Al, and an alloy containing any one of Si, Sn, and Al (such as Sn—Cu alloy). The negative electrode active material preferably comprises Si, Sn, or Al, or an alloy containing any one of Si, Sn, and Al, which is capable of storing a large amount of lithium ions and having a high capacity, and particularly preferably comprises Si that has the highest theoretical capacity.

In a case where the metal material is in a powder form, the metal material has an average particle diameter of preferably 0.01 to 30 μm, 0.05 to 20 μm, or 0.1 to 10 μm, particularly preferably 0.15 to 5 μm. When the metal material has an average particle diameter of more than 30 μm, the resultant negative electrode material is liable to be detached from a current collector due to the volume change caused by the storage and release of lithium ions during charge and discharge. As a result, when conducting repeated charge and discharge, the capacity tends to lower remarkably. On the other hand, when the metal material has an average particle diameter of less than 0.01 μm, it is difficult to mix uniformly the metal material with the oxide containing at least P₂O₅ and/or B₂O₃, and hence it may be difficult to produce a homogeneous electrode. In addition, the specific surface area of the metal material powder increases, and hence, when a paste for forming an electrode, which comprises, for example, a binder and a solvent is prepared, the powder is poorly dispersed so that the addition amounts of the binder and water need to be increased, or the paste has poor coatability, with the result that it tends to be difficult to form a homogeneous electrode.

The metal material has a maximum particle diameter of preferably 200 μm or less, 150 μm or less, 100 μm or less, 50 μm or less, or 30 μm or less, particularly preferably 25 μm or less. When the metal material has a maximum particle diameter of more than 200 μm, the resultant negative electrode material is liable to be detached from a current collector, because the volume change due to the storage and release of lithium ions during charge and discharge is remarkably large. In addition, a crack is liable to occur in particles of the metal material due to repeated charge and discharge, the particles consequently become finely-divided, and hence the electron-conducting network in the electrode material is liable to be divided. As a result, when conducting repeated charge and discharge, the capacity tends to lower remarkably.

The content of the metal material in the negative electrode active material is preferably 5 to 90%, 10 to 70%, or to 50%, particularly preferably 20 to 40%. When the content of the metal material is less than 5%, the initial charge-discharge efficiency tends to lower. On the other hand, when the content of the metal material is more than 90%, the volume change during charge and discharge is liable to be large, and hence the capacity tends to lower during repeated charge and discharge.

Any method of making the oxide material and the metal material complex can be adopted without particular limitations. It is preferred, from the viewpoint of easy handling, to produce mixed powder comprising a powdered oxide material and a powdered metal material. Further, the metal material may be dispersed in the oxide material by heating the mixed powder to a temperature equal to or higher than the softening point of the oxide material. In addition, the surface of the powdered metal material is coated with the oxide material.

The mixed powder comprising the powdered metal material and the powdered oxide material may be prepared by a general technique. For example, dry mixing using a ball mill, a tumbler mill, an oscillating mill, a planetary ball mill, or the like, wet mixing adding an aid such as water or an alcohol, or wet mixing using a rotation-revolution mixer, a propeller stirrer, a bead mill, a jet mill, or the like is applicable.

It is preferred that the negative electrode material comprises a conductive aid. The conductive aid is a component that is added in order to attain a higher capacity and higher rate of the negative electrode material. Specific examples of the conductive aid include highly conductive carbon black such as acetylene black and ketjen black, and metal powders such as Ni powder, Cu powder, and Ag powder. Of those, any one of highly conductive carbon black, Ni powder, and Cu powder, which exerts excellent conductivity even when added in a very small amount, is preferably.

The content of the conductive aid in the negative electrode material is preferably 3 to 20 mass % or 4 to 15 mass %, particularly preferably 5 to 13 mass %. When the content of the conductive aid is less than 3 mass %, an electron-conducting network necessary for sufficiently covering the negative electrode active material cannot be formed, so that the capacity lowers and the high-rate performance deteriorates remarkably. On the other hand, when the content of the conductive aid is more than 20 mass %, the bulk density of the negative electrode material lowers, with the result that the charge-discharge capacity per unit volume of the negative electrode material tends to lower. In addition, the strength of the negative electrode material is liable to lower.

The negative electrode material may be prepared in a paste state in which a material comprising, for example, the negative electrode active material, the binder, and a conductive aid, if necessary, is dispersed in water and is uniformly mixed.

When the negative electrode material for an electricity storage device is coated on the surface of a metal foil and the like serving as a current collector, the resultant can be used as a negative electrode for an electricity storage device.

The thickness of the negative electrode material in the negative electrode material for an electricity storage device can be suitably adjusted depending on targeted capacities, and the thickness is, for example, preferably 1 to 250 μm or 2 to 200 μm, particularly preferably 3 to 150 μm. When the thickness of the negative electrode material is less than 1 μm, there occurred portions partially in which the binder cannot cover the negative electrode active material, and consequently, the cycle performance tends to deteriorate. On the other hand, when the thickness of the negative electrode material is more than 250 μm, when the resultant negative electrode is used in a bended state in a battery, a tensile stress is liable to generate in the surface of the negative electrode material. Thus, a crack is liable to be generated due to the volume change of the negative electrode active material during repeated charge and discharge, and consequently, the cycle performance tends to deteriorate remarkably.

Any method for drying the coating of the negative electrode material on the surface of a current collector may be used without particular limitations, but drying is performed by heat treatment under reduced pressure, under an inert atmosphere, or under a reducing atmosphere at preferably 100 to 400° C. or 120 to 380° C., particularly preferably 140 to 360° C. When the temperature of the heat treatment is less than 100° C., water adsorbing to the negative electrode material is not sufficiently removed. As a result, the remaining water decomposes in an electricity storage device, and oxygen is released, causing explosion, or ignition may be occurred due to heat generation caused by the reaction of the remaining water and lithium, leading to lack of safety. On the other hand, when the temperature of the heat treatment is more than 400° C., the binder is liable to be decomposed. As a result, the binding property lowers, or there occurred portions partially in which the binder cannot cover the negative electrode active material, and consequently, the cycle performance tends to deteriorate.

In the foregoing, description has been made mainly of the negative electrode material for a lithium ion secondary battery. However, the negative electrode material for an electricity storage device of the present invention and the negative electrode for an electricity storage device using the same are not limited thereto, and can also be applied to other non-aqueous secondary batteries and to, for example, a hybrid capacitor in which the negative electrode material for a lithium ion secondary battery and a positive electrode material for a non-aqueous electric double layer capacitor are combined.

A lithium ion capacitor as a hybrid capacitor is a kind of asymmetric capacitor, in which the charge-discharge principle of a positive electrode and that of a negative electrode are different to each other. The lithium ion capacitor has a structure in which a negative electrode for a lithium ion secondary battery and a positive electrode for an electric double layer capacitor are combined. Here, the positive electrode is charged and discharged through a physical action (static electricity action) of an electric double layer formed on surface thereof, whereas the negative electrode is charged and discharged through chemical reactions (storage and release) of lithium ions, in the same manner as in the lithium ion secondary battery described previously.

There is used, for the positive electrode of the lithium ion capacitor, a positive electrode material formed of, for example, carbonaceous powder having a high specific surface area, such as powder of activated carbon, a polyacene, or mesophase carbon. On the other hand, it is possible to use, for the negative electrode, a material in which lithium ions and electrons are stored in the negative electrode material of the present invention.

There is no particular limitation to means for storing lithium ions and electrons in the negative electrode material. For example, a metal lithium electrode serving as supply sources of lithium ions and electrons is provided in a capacitor cell and is brought into contact with a negative electrode comprising the negative electrode material of the present invention directly or through an electric conductor, or lithium ions and electrons are preliminarily stored in the negative electrode material of the present invention in a different cell and the negative electrode material is installed in a capacitor cell.

### EXAMPLES

Hereinafter, as an example of the negative electrode material for an electricity storage device of the present invention, a negative electrode material for a non-aqueous secondary battery is described in detail by way of examples, but the present invention is not limited to these examples.

(1) Preparation of negative electrode active material for non-aqueous secondary battery

As for the oxide materials listed in Examples 1 to 13, 15, and 16, and Comparative Examples 1 and 2, a raw material was blended by using a complex oxide of tin and phosphorus (stannous pyrophosphate: Sn₂P₂O₇) as the main material together with various oxides, a carbonate material, and the like so that compositions shown in Tables 1 to 4 were attained. The raw material was fed into a quartz crucible and was melted in a nitrogen atmosphere at 950° C. for 40 minutes in an electric furnace to be vitrified. Further, as for the oxide material listed in Example 14, a raw material was blended by using various oxides, a carbonate raw material, and the like so that the composition shown in Table 2 was attained. The raw material was fed into a platinum crucible and was melted in an air atmosphere at 1400° C. for 40 minutes in an electric furnace to be vitrified.

Next, the molten glass was poured between a pair of rotating rollers and was formed into a film-shaped glass having a thickness of 0.1 to 2 mm while being quenched. The film-shaped glass was fed into a ball mill containing zirconia balls with diameters of 2 to 3 cm and was pulverized at 100 rpm for 3 hours. The pulverized glass was then passed through a resin sieve having a mesh size of 120 μm, yielding coarse glass powder having an average particle diameter of 3 to 15 μm. Subsequently, the coarse glass powder was subjected to air classification, yielding glass powder (oxide powder) having an average particle diameter of 2 μm and a maximum particle diameter of 28 μm.

As for the oxide material listed in Comparative Example 7, a raw material of stannous oxide was used without any treatment. Note that the raw material of stannous oxide has an average particle diameter of 2.5 μm and a maximum particle diameter of 28 μm.

Each oxide material powder was subjected to powder X-ray diffraction measurement to identify its structure. The oxide materials of Examples 1 to 16 and Comparative Examples 1 and 2 were amorphous and no crystal was detected.

In Examples 12 to 14 and Comparative Examples 2 to 6, with respect to each of the oxide materials thus obtained, metal material powder listed in Tables 2 and 4 was fed into a container at each ratio, and the contents were mixed by using a ball mill, yielding each negative electrode active material. Note that Si powder was selected to have an average particle diameter of 2.1 μm and a maximum particle diameter of 8.9 μm.

(2) Preparation of Negative Electrode for Non-Aqueous Secondary Battery

Each negative electrode active material thus obtained, a conductive aid, and a binder were weighed so as to make the composition of each negative electrode material shown in Tables 1 to 4, and were dispersed in a solvent, followed by sufficiently stirring with a rotation-revolution mixer, yielding a slurry. Herein, as the binder, carboxymethyl cellulose (CMC) (manufactured by Daicel FineChem. Ltd.) were used in Examples 1 to 14 and Comparative Examples 3 to 7, a mixture of CMC and polyvinyl alcohol (PVA) (manufactured by KURARAY CO., LTD.) were used in Examples 15 and 16, and polyvinylidene fluoride (PVDF) (manufactured by Kishida Chemical Co., Ltd.) were used in Comparative Examples 1 and 2. In addition, a Ketjen black (KB) (manufactured by Lion Corporation) was used as the conductive aid. Note that the CMC was dispersed in pure water, and the PVDF was dispersed in an N-methylpyrrolidinone solvent.

Next, a doctor blade with a gap of 100 μm was used to coat the resultant slurry on a copper foil having a thickness of 20 μm and serving as a negative electrode current collector, and the coated copper foil was dried with a dryer at 70° C. and was then passed through a pair of rotating rollers, yielding an electrode sheet. The electrode sheet was punched out with a punching machine into a piece having a diameter of 11 mm, and then was dried under reduced pressure, yielding a circular working electrode (negative electrode for a non-aqueous secondary battery). Note that the drying of each electrode sheet thus obtained was carried out at a temperature of 160° C. for 3 hours with respect to Examples 1 to 16 and Comparative Examples 3 to 7, and at a temperature of 140° C. for 4 hours with respect to Comparative Examples 1 and 2.

(3) Preparation of Test Battery

The working electrode was placed, with its copper foil surface facing downward, on a lower lid of a coin cell, and there were laminated, on the working electrode, a separator formed of a polypropylene porous film (Celgard #2400 manufactured by Hoechst Celanese Corporation) having a diameter of 16 mm, which had been dried under reduced pressure at 70° C. for 8 hours, and metal lithium serving as an opposite electrode, thus obtaining a test battery. Used as an electrolytic solution was a 1 M LiPF₆ solution/EC:DEC=1:1 (EC=ethylene carbonate, DEC=diethyl carbonate). Note that the assembly of the test battery was carried out in an environment of a dew-point temperature of −50° C. or less.

(4) Charge-Discharge Test

Charge (storage of Li ions in the negative electrode active material) was carried out with a 0.2-mA constant current (CC) from 1 V to 0 V. Next, discharge (release of Li ions from the negative electrode active material) was carried out with at a constant current of 0.2 mA from 0 V to 1 V. This charge-discharge cycle was repeated, and the charge capacity and the discharge capacity per unit mass of the negative electrode active material were measured.

The results of initial charge-discharge performance and cycle performances, when repeated charge and discharge was carried out in the charge-discharge test for the batteries using the negative electrode active material of Examples and Comparative Examples, are shown in Tables 1 to 4 as the discharge capacity retention rate (the ratio of the discharge capacity after 100th cycle to the initial discharge capacity).

(5) High-Rate Test

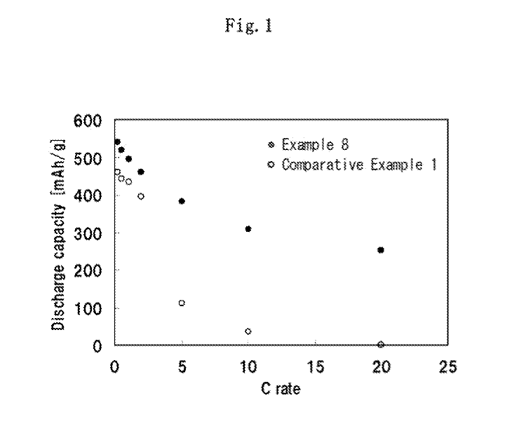

A high-rate test was applied to each test battery using each negative electrode for a non-aqueous secondary battery in Example 8 and Comparative Example 1. The conditions of the test were as follows. Charge was carried out with a 0.2 C constant current from 1 V to 0 V. In order to carry out discharge, the current value was set so as to achieve each rate of 0.2 C, 0.5 C, 1 C, 2 C, 5 C, 10 C, and 20 C, and the discharge was carried out with a constant current from 0 V to 1 V. FIG. 1 shows the results.

TABLE 1

| | | Example | | | | | | | | | | |
|---|---|---|---|---|---|---|---|---|---|---|---|---|
| | | 1 | 2 | 3 | 4 | 5 | 6 | 7 | 8 | 9 | 10 | 11 |
| Negative | SnO | 72 | 72 | 72 | 72 | 72 | 72 | 72 | 72 | 72 | 86 | 63 |
| electrode | P₂O₅ | 28 | 28 | 28 | 28 | 28 | 28 | 28 | 28 | 28 | 14 | 20 |
| active | Al₂O₃ | | | | | | | | | | | 3 |
| material | B₂O₃ | | | | | | | | | | | 11 |
| (mol %) | MgO | | | | | | | | | | | 3 |
| | SnO/P₂O₅ | 2.6 | 2.6 | 2.6 | 2.6 | 2.6 | 2.6 | 2.6 | 2.6 | 2.6 | 6.1 | 3.2 |
| Precipitated crystal | | Absent | Absent | Absent | Absent | Absent | Absent | Absent | Absent | Absent | Absent | Absent |
| (Crystallinity (%)) | | | | | | | | | | | | |
| Negative | Negative electrode | 93 | 92 | 91 | 90 | 89 | 88 | 87 | 85 | 75 | 85 | 85 |
| electrode | active material | | | | | | | | | | | |
| material | Binder | 2 | 3 | 4 | 5 | 6 | 7 | 8 | 10 | 20 | 10 | 10 |
| (mass %) | (CMC) | | | | | | | | | | | |
| | Conductive aid | 5 | 5 | 5 | 5 | 5 | 5 | 5 | 5 | 5 | 5 | 5 |
| | (KB) | | | | | | | | | | | |
| Charge- | Initial charge | 909 | 1002 | 985 | 1030 | 1048 | 1046 | 1070 | 1063 | 1131 | 1118 | 1065 |
| discharge | capacity (mAh/g) | | | | | | | | | | | |
| performance | Initial discharge | 463 | 490 | 492 | 505 | 510 | 509 | 513 | 520 | 550 | 590 | 521 |
| | capacity (mAh/g) | | | | | | | | | | | |
| | Initial | 50.9 | 48.9 | 49.9 | 49.0 | 48.7 | 48.7 | 47.9 | 48.9 | 48.6 | 52.8 | 48.9 |
| | charge-discharge | | | | | | | | | | | |
| | efficiency (%) | | | | | | | | | | | |
| | Discharge capacity | 72.9 | 82.5 | 85 | 85.3 | 89.5 | 90.1 | 92.4 | 94.3 | 99.0 | 86.4 | 89.5 |
| | retention rate (%) | | | | | | | | | | | |

TABLE 2

| | | | | Example | | |
|---|---|---|---|---|---|---|
| | | | | 12 | 13 | 14 |
| Negative | Oxide | Composi- | SnO | 72 | 72 | |
| electrode | material | tion | P₂O₅ | 28 | 28 | 57.6 |
| active | | (mol %) | Al₂O₃ | | | 17.1 |
| material | | | B₂O₃ | | | 5.9 |
| | | | BaO | | | 2.7 |
| | | | Fe₂O₃ | | | 1.8 |
| | | | SiO₂ | | | 1.9 |
| | | | MgO | | | 13 |
| | | | SnO/P₂O₅ | 2.6 | 2.6 | — |

| | | | |
|---|---|---|---|
| Precipitated crystal | Absent | Absent | Absent |
| (Crystallinity (%)) | | | |

| | | | |
|---|---|---|---|
| Metal Material | Si | Si | Si |

| | | | | |
|---|---|---|---|---|
| Composition of | Metal material | 75 | 70 | 70 |
| negative electrode | Oxide material | 25 | 30 | 30 |
| active material | | | | |
| (mass %) | | | | |
| Negative electrode | Negative electrode | 80 | 80 | 80 |
| material (mass %) | active material | | | |
| | Binder | 15 | 15 | 15 |
| | (CMC) | | | |
| | Conductive aid | 5 | 5 | 5 |
| | (KB) | | | |
| Charge-discharge | Initial charge | 3237 | 2900 | 3010 |
| performance | capacity (mAh/g) | | | |
| | Initial discharge | 2265 | 1970 | 2555 |
| | capacity (mAh/g) | | | |
| | Initial charge- | 70.0 | 67.9 | 84.9 |
| | discharge | | | |
| | efficiency (%) | | | |
| | Discharge capacity | 75.1 | 82.3 | 89.3 |
| | retention rate (%) | | | |

TABLE 3

Example

| | | 15 | 16 |
|---|---|---|---|
| Negative | SnO | 72 | 72 |
| electrode active | P₂O₅ | 28 | 28 |
| material (mol %) | Al₂O₃ | | |
| | B₂O₃ | | |
| | BaO | | |
| | Fe₂O₃ | | |
| | SiO₂ | | |
| | MgO | | |
| | SnO/P₂O₅ | 2.6 | 2.6 |
| Precipitated crystal | | Absent | Absent |
| (Crystallinity (%)) | | | |
| Negative electrode | Negative electrode | 87 | 87 |
| material (mass %) | active material | | |
| | Binder | 4 + 4 | 6 + 2 |
| | (CMC + PVA) | | |
| | Conductive aid | 5 | 5 |
| | (KB) | | |
| Charge-discharge | Initial charge | 1046 | 1033 |
| performance | capacity (mAh/g) | | |
| | Initial discharge | 504 | 505 |
| | capacity (mAh/g) | | |
| | Initial | 48.2 | 48.9 |
| | charge-discharge | | |
| | efficiency (%) | | |
| | Discharge capacity | 87.5 | 90.2 |
| | retention rate (%) | | |

TABLE 4

| Comparative Example | | | | | | |
|---|---|---|---|---|---|---|
| 1 | 2 | 3 | 4 | 5 | 6 | 7 |

| | | | | | | |
|---|---|---|---|---|---|---|
| Negative | Oxide | Composition | SnO | 68 | 71 | 100 |
| electrode | material | (mol %) | P₂O₅ | 32 | 29 | |
| active | | | Al₂O₃ | | | |
| material | | | B₂O₃ | | | |
| | | | BaO | | | |
| | | | Fe₂O₃ | | | |
| | | | SiO₂ | | | |
| | | | MgO | | | |
| | | | SnO/P₂O₅ | 2.1 | 2.4 | |

| | | | | | | | |
|---|---|---|---|---|---|---|---|
| Precipitated crystal | Absent | Absent | — | — | — | — | SnO (100) |
| (Crystallinity (%)) | | | | | | | |

| | | | | | |
|---|---|---|---|---|---|
| Metal Material | Si | Si | Si | Si | Si |

| | | | | | | | | |
|---|---|---|---|---|---|---|---|---|
| Composition | Metal material | — | 75 | 100 | 100 | 100 | 100 | — |
| of negative | Oxide material | 100 | 25 | — | — | — | — | 100 |
| electrode active | | | | | | | | |
| material (mass %) | | | | | | | | |
| Negative electrode | Negative electrode | 85 | 80 | 84 | 82 | 80 | 80 | 80 |
| material (mass %) | active material | | | | | | | |
| | Binder | 10 PVDF | 15 PVDF | 6 CMC | 8 CMC | 10 CMC | 15 CMC | 15 CMC |
| | Conductive aid | 5 | 5 | 10 | 10 | 10 | 5 | 5 |
| | (KB) | | | | | | | |
| Charge-discharge | Initial charge | 1015 | 3120 | 3642 | 3706 | 3719 | 3754 | 1282 |
| performance | capacity (mAh/g) | | | | | | | |
| | Initial discharge | 452 | 1320 | 2075 | 2519 | 3065 | 3098 | 627 |
| | capacity (mAh/g) | | | | | | | |
| | Initial charge-discharge | 44.5 | 42.3 | 57.0 | 68.0 | 82.4 | 82.5 | 48.9 |
| | efficiency (%) | | | | | | | |
| | Discharge capacity | 23.2 | 3.4 | 0.7 | 2 | 4.1 | 8.2 | 19 |
| | retention rate (%) | | | | | | | |

In Examples 1 to 16, the initial discharge capacity was 463 mAh/g or more, the initial charge-discharge efficiency was 47.9% or more, the discharge capacity retention rate was 72.9% or more, which were good results. In particular, in Examples 12 to 14, in which each negative electrode active material comprises the oxide material and the metal material, the initial discharge capacity was 1970 mAh/g or more, the initial charge-discharge efficiency was 67.9% or more, and the discharge capacity retention rate was 75.1% or more, which exhibited very good performances. On the other hand, in Comparative Examples 1 and 2, in which PVDF was used as a binder, and in Comparative Examples 3 to 7, in which no oxide material comprising P₂O₅ and/or B₂O₃ was used as a negative electrode active material, the initial discharge capacity was 452 mAh/g or more and the initial charge-discharge efficiency was 44.5% or more, but the discharge capacity retention rate after the 100th cycle remarkably lowered to as low as 23.2% or less.

Further, as evident from FIG. 1, in Example 8, in which CMC was used as a binder, the discharge capacity at 20 C rate was 253 mAh/g, whereas in Comparative Example 1, in which PVDF was used as a binder, the discharge capacity at 20 C rate remarkably lowered to as low as 0 mAh/g.

1. A negative electrode material for an electricity storage device, comprising:
a negative electrode active material containing an oxide material; and
a binder made of a water-soluble polymer.

2. The negative electrode material for an electricity storage device according to claim 1, wherein the water-soluble polymer comprises a cellulose derivative or polyvinyl alcohol.

3. The negative electrode material for an electricity storage device according to claim 1, which comprises the binder at 2 to 30 mass %.

4. The negative electrode material for an electricity storage device according to claim 1, wherein the oxide material comprises P₂O₅ and/or B₂O₃.

5. The negative electrode material for an electricity storage device according to claim 4, wherein the oxide material is made of a compound comprising P₂O₅ and/or B₂O₃ and SnO.

6. The negative electrode material for an electricity storage device according to claim 5, wherein the oxide material comprises, as a composition in terms of mol %, 45 to 95% of SnO and 5 to 55% of P₂O₅.

7. The negative electrode material for an electricity storage device according to claim 5, wherein the oxide material comprises, as a composition in terms of mol %, 10 to 85% of SnO, 3 to 90% of B₂O₃, and 0 to 55% of P₂O₅, provided that B₂O₃+P₂O₅ is 15% or more.

8. The negative electrode material for an electricity storage device according to claim 1, further comprising at least one kind of metal material selected from Si, Sn, Al, and an alloy containing any one of Si, Sn, and Al.

9. The negative electrode material for an electricity storage device according to claim 1, further comprising a conductive aid.

10. A negative electrode for an electricity storage device, comprising a current collector having a surface coated with the negative electrode material for an electricity storage device according to claim 1.
